(19) United States
(12) Patent Application Publication
(10) Pub. No.: US 2026/0145619 A1
(43) Pub. Date: May 28, 2026

(54) VEHICLE HAVING A META STRUCTURED ROOF RACK SYSTEM

(71) Applicant: FCA US LLC, Auburn Hills, MI (US)

(72) Inventors: Gurumoorthy Sankarasubramanian, Chennai (IN); Suresh Kumar R, Chennai (IN)

(21) Appl. No.: 18/960,349

(22) Filed: Nov. 26, 2024

(51) Int. Cl. B60R 9/052

(52) U.S. Cl. CPC B60R 9/052

(57) ABSTRACT

A roof rack assembly configured to be attached to the roof of a vehicle, the roof rack assembly comprising a pair of rails that are configured to be attached to a roof of the vehicle; and a plurality of cross-bar assemblies that are configured to extend orthogonally between and connected to the pair of rails, each cross-bar assembly including a cross-bar having an auxetic interior support structure that includes a plurality of sub-structures that define an auxetic pattern.

### FIELD

The present disclosure relates to a vehicle having a meta structured roof rack system.

### BACKGROUND

This section provides background information related to the present disclosure which is not necessarily prior art.

A roof rack system of a vehicle typically includes a pair of side rails that extend along at least a portion of a length of a roof of the vehicle, and a plurality of cross bars that extend orthogonally relative to and between the side rails. In general, the cross bars may be formed from a rigid material such as aluminum or a composite material to ensure that the cross bars maintain structural integrity in the event of the vehicle experiencing a rollover incident. In this regard, it is desirable that the cross bars do not bend, break, collapse, or detach from the vehicle in the event that the vehicle experiences a rollover incident. Aluminum and composite cross bars, however, are not as easily customizable from an aerodynamic perspective, can sometimes produce undesirable noise and vibrations during travel, and can sometimes intrude through the roof during a rollover incident. Accordingly, there is room for improvement in vehicle roof rack systems.

### SUMMARY

This section provides a general summary of the disclosure, and is not a comprehensive disclosure of its full scope or all of its features.

According to a first aspect of the present disclosure there is provided a vehicle having a body including a roof, wherein the vehicle comprises a roof rack assembly attached to the roof of the vehicle that includes a pair of rails that extend along a longitudinal length of the roof and a plurality of cross-bar assemblies that extend orthogonally between and connected to the pair of rails, each cross-bar assembly including a cross-bar having an auxetic interior support structure that includes a plurality of sub-structures that define an auxetic pattern.

According to the first aspect, each sub-structure includes a cavity that is encapsulated by walls of adjacent sub-structures.

According to the first aspect, each cavity of each sub-structure is the same size.

According to the first aspect, upon application of a force to the cross-bar, a volume of the cavity is configured to change.

According to the first aspect, the walls of each sub-structure provide the cavity with a diamond shape.

According to the first aspect, the walls of each sub-structure define an X-shaped cavity.

According to the first aspect, the walls that provide the cavity with a diamond shape are connected to the walls of an adjacent cavity having the diamond shape.

According to the first aspect, the cavity of one sub-structure has a size that is different from the cavity of another sub-structure.

According to a second aspect of the present disclosure, there is provided a roof rack assembly configured to be attached to the roof of a vehicle. The roof rack assembly comprises a pair of rails that are configured to be attached to a roof of the vehicle; and a plurality of cross-bar assemblies that are configured to extend orthogonally between and connected to the pair of rails, each cross-bar assembly including a cross-bar having an auxetic interior support structure that includes a plurality of sub-structures that define an auxetic pattern.

According to the second aspect, each sub-structure includes a cavity that is encapsulated by walls of adjacent sub-structures.

According to the second aspect, each cavity of each sub-structure is the same size.

According to the second aspect, upon application of a force to the cross-bar, a volume of the cavity is configured to change.

According to the second aspect, the walls of each sub-structure provide the cavity with a diamond shape.

According to the second aspect, the walls of each sub-structure define an X-shaped cavity.

According to the second aspect, the walls that provide the cavity with a diamond shape are connected to the walls of an adjacent cavity having the diamond shape.

According to the second aspect, the cavity of one sub-structure has a size that is different from the cavity of another sub-structure.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates an example vehicle having a roof rack system according to a principle of the present disclosure;

FIG. 2 illustrates cross-bar assemblies that may be part of the roof rack system illustrated in FIG. 1;

FIG. 3 is a cross-sectional view of a cross-bar of the cross-bar assemblies illustrated in FIG. 2; and

FIGS. 4A and 4B are cross-sectional views of example auxetic support structures that may be used in an interior of the cross-bar illustrated in FIG. 3.

Corresponding reference numerals indicate corresponding parts throughout the several views of the drawings.

### DETAILED DESCRIPTION

Example embodiments will now be described more fully with reference to the accompanying drawings. The example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

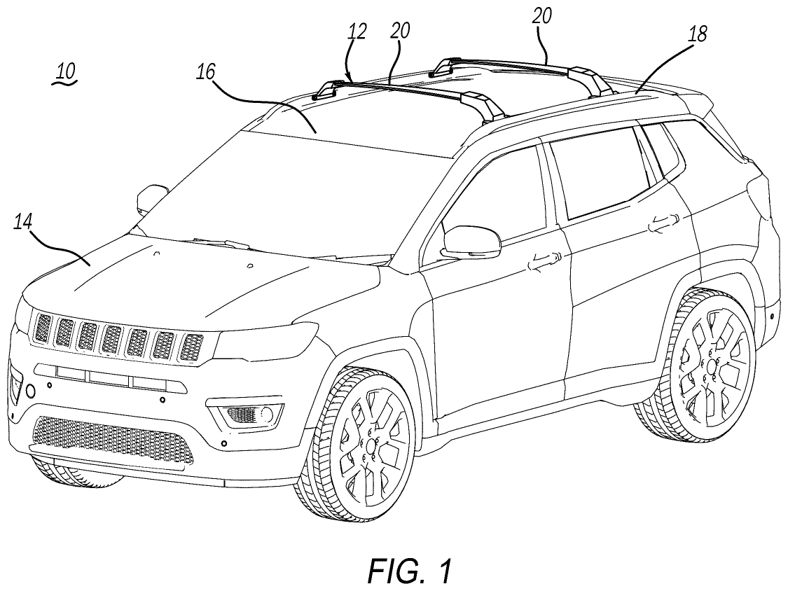

FIG. 1 illustrates an example vehicle 10 having a roof rack system 12 according to a principle of the present disclosure. Vehicle 10 includes a body 14 including a roof 16, to which roof rack system 12 is attached. Roof rack system 12 includes a pair of rails 18 that extend along a longitudinal length of roof 16, and a plurality of cross-bar assemblies 20 that are attached to rails 18. Cross-bar assemblies 20 extend orthogonally relative to and between rails 18, across a width of vehicle 10.

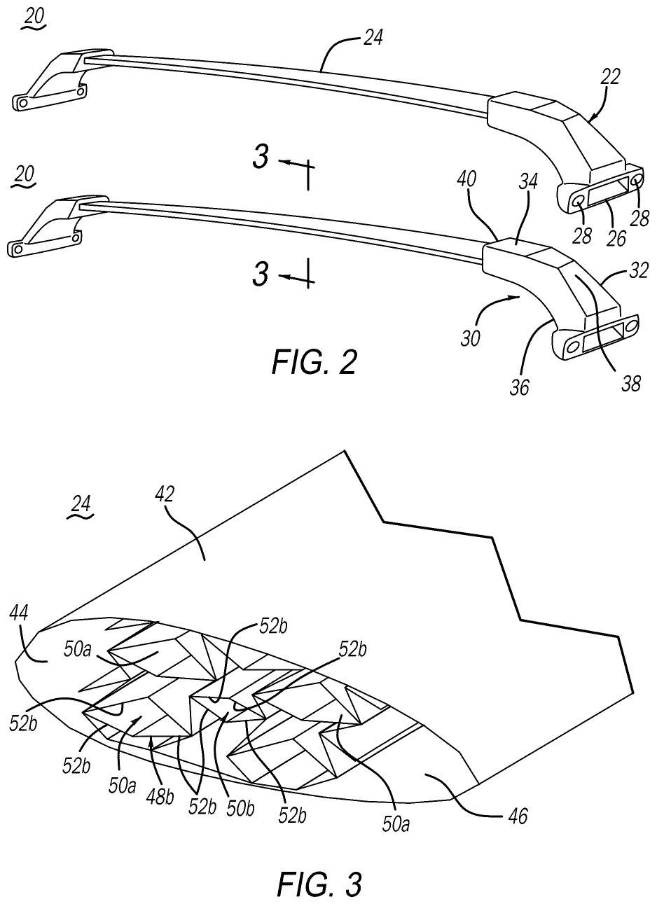

Cross-bar assemblies 20 are shown in more detail in FIG. 2. Referring to FIG. 2, cross-bar assemblies 20 each include a pair of brackets 22 that are configured to connect cross-bar assemblies 20 to rails 18. A cross-bar 24 is connected to and extends between brackets 22. Brackets 22 may be formed of a rigid material such as rigid metal material (e.g., aluminum or steel) or a composite material such as glass-reinforced polyamide (e.g., NYLON®). Brackets 22 each include a base 26 that includes a pair of apertures 28 that are each configured for receipt of a fastener (not shown) such as a screw that can be used to secure brackets 22 to rails 18. An arm 30 including a first section 32 and a second section 34 extends outward from base 26. First section 32 includes a proximate end 36 connected to or unitary with base 26 and a distal end 38 to which second section 34 is attached or unitary therewith. Second section 34 includes an open end 40 that is configured for receipt of an end of cross-bar 24.

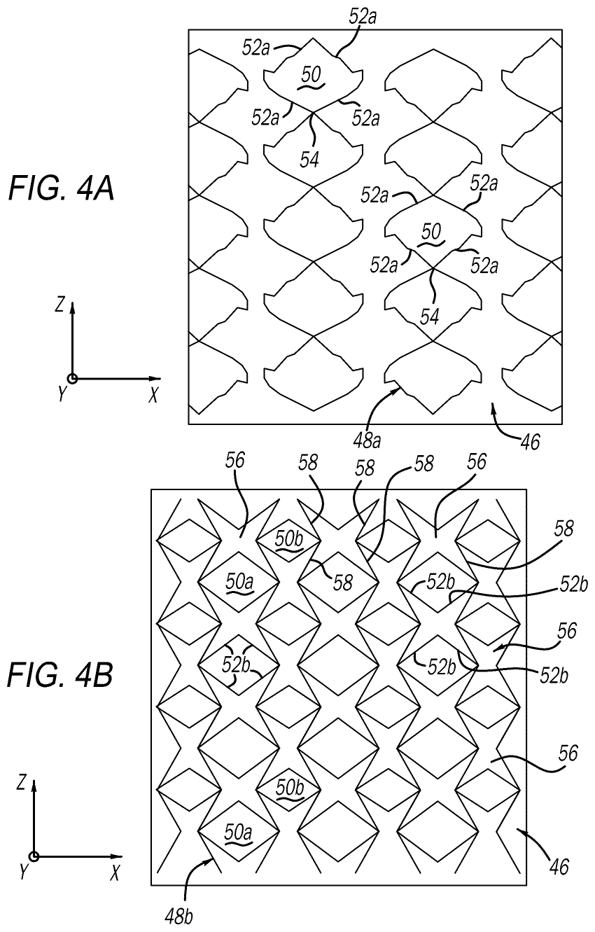

Now referring to FIGS. 3, 4A, and 4B with continued reference to FIG. 2, cross-bars 24 each include a longitudinally extending body 42 having an outer shell 44 that houses an interior support structure 46. Outer shell 44 and interior support structure 46 may each be formed of a rigid material such as a polymeric material, and may be unitary with each other (i.e., injection molded and formed in the same process). Alternatively, interior support structure 46 may first be formed and then outer shell 44 formed overtop thereof. Example polymeric materials include glass-reinforced polyamide. If interior support structure 46 is formed separate from outer shell 44, outer shell 44 and interior support structure 46 may be formed of different materials. It is preferable, however, that outer shell 44 and interior support structure 46 are formed of the same polymeric material.

As best shown in FIGS. 3, 4A, and 4B interior support structure 46 may be auxetic in nature such that interior support structure 46 exhibits a negative Poisson's ratio. Poisson's ratio is a measure of the Poisson effect, the phenomenon in which a material tends to expand in directions perpendicular to the direction of compression. Conversely, if the material is stretched rather than compressed, the material usually tends to contract in the directions transverse to the direction of stretching. The Poisson ratio is a ratio of relative contraction to relative expansion. In certain rare cases, a material can shrink in the transverse direction when compressed (or expand when stretched), which yields a negative value of the Poisson ratio. The negative Poisson ratio of interior support structure 46 indicates that when interior support structure 46 is elongated in a first direction, the interior support structure 46 will also experience an increase in elongation in a second direction that is transverse to the first direction. Auxetic structures, therefore, can be effective in absorbing a greater amount of force if vehicle 10 is subjected to a rollover event.

The example interior support structures 46 shown in FIGS. 4A and 4B exhibit a negative Poisson's ratio because of the uniquely oriented and hinged sub-structures or cells 48a (FIG. 4A) and 48b (FIG. 4B), respectively, that define an auxetic pattern. Sub-structures 48a and 48b, when compressed in any of the directions x, y, and z, are configured to expand in directions arranged orthogonal to the direction of compression. For example, if sub-structures 48 are compressed in the z-direction, the sub-structures 48 are configured to expand in each of the x-and y-directions.

Each sub-structure 48a and 48b defines a cavity 50 that may be filled with a gas such as air. It should be understood, however, that cavity 50 may be filled with other gases or fluids (e.g., liquids) if desired. Cavities 50 are surrounded or encapsulated by walls 52a (FIG. 4A) and 52b (FIG. 4B). The walls 52a may be connected to each other in a manner where sub-structures 48a are diamond-shaped and interconnected in the z-direction at apexes 54. The connected terminal apexes 54 and walls 52a act as hinges that permit cells 48a to move in any of the directions x, y, and z dependent on the forces exerted on cross-bar 24. In addition, the connected terminal apexes 54 and walls 52a permit a volume of cavities 50 to change (i.e., expand or contract) in response to the forces exerted on cross-bar 24. In FIG. 4A, each cavity 50 may be the same (i.e., have the same dimensions).

FIG. 4B, in contrast, depicts a configuration where cavities 50 may be different. That is, FIG. 4B illustrates an interior support structure 46 having first walls 52b that define first diamond-shaped cavities 50a that have a larger volume in comparison to second diamond-shaped cavities 50b. The different sized diamond-shaped cavities 50a and 50b may permit an even greater amount of energy absorption by interior support structure 46. In the illustrated embodiment, first diamond-shaped cavities 50a are aligned in each of the z-and x-directions, while second diamond-shaped cavities 50b are also aligned in each of the z-and x-directions. It should be understood, however, that second diamond-shaped cavities 50b can be interposed between first diamond-shaped cavities 50a in any of the x-, y, or z-directions, if desired.

Sub-structures 48b also include X-shaped cavities 56 that formed by some of the first walls 52b that define the first and second diamond-shaped cavities 50a and 50, and second walls 58 that area connected to the first walls 52b. Each X-shaped cavity 56 is connected to a pair of the first diamond-shaped cavities 50a and a pair of the second diamond-shaped cavities 50b. The connection between the first walls 52b and second walls 58 arms that define the X-shaped cavities 56 and diamond-shaped cavities 50a, 50b function like hinges that permit the cavities 50a, 50b, and 56 to move in any of the directions x, y, and z dependent on the forces exerted on cross-bar 24. In addition, the connected first and second arms 52b, 58 permit a volume of cavities 50a, 50b, and 56 to change (i.e., expand or contract) in response to the forces exerted on cross-bar 24.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle having a body including a roof, the vehicle comprising a roof rack assembly attached to the roof of the vehicle that includes a pair of rails that extend along a longitudinal length of the roof and a plurality of cross-bar assemblies that extend orthogonally between and connected to the pair of rails, each cross-bar assembly including a cross-bar having an auxetic interior support structure that includes a plurality of sub-structures that define an auxetic pattern.

2. The vehicle according to claim 1, wherein each sub-structure includes a cavity that is encapsulated by walls of adjacent sub-structures.

3. The vehicle according to claim 2, wherein each cavity of each sub-structure is the same size.

4. The vehicle according to claim 2, wherein upon application of a force to the cross-bar, a volume of the cavity is configured to change.

5. The vehicle according to claim 2, wherein the walls of each sub-structure provide the cavity with a diamond shape.

6. The vehicle according to claim 5, wherein the walls of each sub-structure define an X-shaped cavity.

7. The vehicle according to claim 5, wherein the walls that provide the cavity with a diamond shape are connected to the walls of an adjacent cavity having the diamond shape.

8. The vehicle according to claim 2, wherein the cavity of one sub-structure has a size that is different from the cavity of another sub-structure.

9. A roof rack assembly configured to be attached to the roof of a vehicle, the roof rack assembly comprising:
a pair of rails that are configured to be attached to a roof of the vehicle; and
a plurality of cross-bar assemblies that are configured to extend orthogonally between and connected to the pair of rails, each cross-bar assembly including a cross-bar having an auxetic interior support structure that includes a plurality of sub-structures that define an auxetic pattern.

10. The roof rack assembly according to claim 9, wherein each sub-structure includes a cavity that is encapsulated by walls of adjacent sub-structures.

11. The roof rack assembly according to claim 10, wherein each cavity of each sub-structure is the same size.

12. The roof rack assembly according to claim 10, wherein upon application of a force to the cross-bar, a volume of the cavity is configured to change.

13. The roof rack assembly according to claim 10, wherein the walls of each sub-structure provide the cavity with a diamond shape.

14. The roof rack assembly according to claim 13, wherein the walls of each sub-structure define an X-shaped cavity.

15. The roof rack assembly according to claim 13, wherein the walls that provide the cavity with a diamond shape are connected to the walls of an adjacent cavity having the diamond shape.

16. The roof rack assembly according to claim 10, wherein the cavity of one sub-structure has a size that is different from the cavity of another sub-structure.
